(19) United States
(12) Patent Application Publication
(10) Pub. No.: US 2009/0303628 A1
(43) Pub. Date: Dec. 10, 2009

(54) DATA MANAGING METHOD, INFORMATION STORAGE APPARATUS, AND DATA MANGEMENT CIRCUIT

(75) Inventors: Nobuhiro Sugawara, Kawasaki (JP); Michio Yamamoto, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/391,900

(22) Filed: Feb. 24, 2009

(30) Foreign Application Priority Data
Jun. 4, 2008 (JP) 2008-147050

(51) Int. Cl. G11B 27/36

(52) U.S. Cl. 360/31

(57) ABSTRACT

A magnetic disk device regularly monitors an abnormality in heads and, when detecting an abnormality in any head, transfers data in each cell corresponding to the head where the abnormality is detected to a replacement cell corresponding to another head. Then, in a management table, the magnetic disk device updates the logical address of the transfer-destination cell to the logical address of the transfer-source cell. Thereafter, the magnetic disk device deletes the data in the transfer-destination cell from the management table.

### CROSS-REFERENCE TO RELATED APPLICATION(S)

This application is based upon and claims the benefit of priority of the prior Japanese Patent Application No. 2008-147050, filed on Jun. 4, 2008, the entire contents of which are incorporated herein by reference.

### FIELD

The embodiments discussed herein are directed to a data managing method, information storage apparatus, and data management circuit in which, when an abnormal head is detected, data corresponding to the abnormal head is transferred to a recording region corresponding to another head.

### BACKGROUND

Conventionally, in an information storage apparatus (for example, a magnetic disk device) reading (reproducing) and writing (recording) data from and into a medium surface by using a head, when a degradation or failure occurs in the head, a state may occur such that a large amount of data may be lost.

In an information recording apparatus that manages data by a sector, which is a minimum recording unit in a storage medium, when a sector fails to successfully read and write due to a defect in the medium, data assigned to that sector is moved to a reserve sector allocated at another place for continue the operation. This technology is known as a replacement sector (see Japanese Laid-open Patent Publication No. 06-338004).

However, when data is managed by sectors, physical address information about a destination for saving data of each sector has to be stored, and the save-destination information has to be searched for each sector at every access. Moreover, when a trouble occurs in the head, an enormous amount of data has to be saved, and such a large amount data of sectors included in the troubled head has to be saved for management.

To do this, in one known method, a plurality of sectors are taken as a unit (for example, a cell or a zone), and a sector groups is sectioned in units of cells (or zones) for managing data (see Japanese Laid-open Patent Publication No. 2001-101842). In an information recording apparatus that manages data in units of cells (or zones), a management table is provided having stored therein an index that uniquely identifies each cell, a logical address of data assigned to each cell, and a physical storage position of data in association with one another (see FIG. 16).

In an information storage apparatus that manages data in units of cells, when a trouble occurs in the head, data in a cell served by the troubled head is transferred to another cell to update the management table. Specifically, by using an example depicted in FIG. 16, when a trouble occurs in the head, data stored in a cell 2 served by the troubled head is transferred to a cell 4, the logical address of data in the cell 4 (transfer-destination cell) in the management table is rewritten as “51-100”, which is used to be a logical address of the cell 2 (transfer-source cell).

However, in the technology explained above in which the information recording apparatus managing data in units of cells updates the management table, only the logical address of the transfer-destination cell is rewritten as the logical address of the transfer-source cell, and the cell index corresponding to the physical position of the data is not changed.

Therefore, when the operation continue after trouble, software or the like managing the cells by using cell indexes has to be modified, or a table that separately manages the fact that the data stored in the transfer-destination cell is data stored in the transfer-source cell has to be added. As a result, a problem arises in which it is not easy to continue the operation when a trouble occurs.

### SUMMARY

According to an aspect of the invention, a data managing method includes monitoring an abnormality in a plurality of heads that read and write data from and into a recording medium; transferring data in a recording region corresponding to the head where an abnormality is detected in one of the heads at the monitoring to a recording region corresponding to another head; and updating a management table when the data is transferred at the transferring, the management table storing an index that uniquely identifies a sector group with a plurality of sectors being taken as one unit, a physical position of each storage region of the storage medium, and a logical address in association with one another, so as to update a logical address of a transfer destination to a logical address of a transfer source and to update an index of the transfer destination to an index of the transfer source.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of the configuration of a disk device according to a first embodiment;

FIG. 2 is a drawing for explaining a disk and a head;

FIG. 3 is a drawing for explaining the disk and the head;

FIG. 4 is a drawing for explaining zones of the disk;

FIG. 5 is a drawing for explaining cells of the disk;

FIG. 6 is a drawing for explaining a management table;

FIG. 7 is a drawing for explaining a data transferring process;

FIG. 8 is a drawing for explaining a state after the data transferring process is performed;

FIG. 9 is a drawing for explaining the data transferring process;

FIG. 10 is a drawing for explaining a management-table updating process;

FIG. 11 is a drawing for explaining the management table after the management-table updating process;

FIG. 12 is a flowchart of the process operation of a magnetic disk device 10 according to the first embodiment;

FIG. 13 is a drawing for explaining a management table after the management-table updating process;

FIG. 14 is a drawing for explaining zones of the disk;

FIG. 15 is a drawing for explaining a data transferring process by zone; and

FIG. 16 is a drawing for explaining a conventional technology.

### DESCRIPTION OF EMBODIMENTS

Preferred embodiments of the present invention will be explained with reference to accompanying drawings.

### [a] First Embodiment

In the following, the configuration and process flow of a magnetic disk device according to a first embodiment are sequentially explained, and finally, effects of the first embodiment are explained. Also, in the following, a magnetic disk device is taken as an example of a storage device. However, the present invention can be applied to storage devices other than the magnetic disk device, such as a storage device of a magneto-optical disk device or the like.

### Configuration of the Magnetic Disk Device

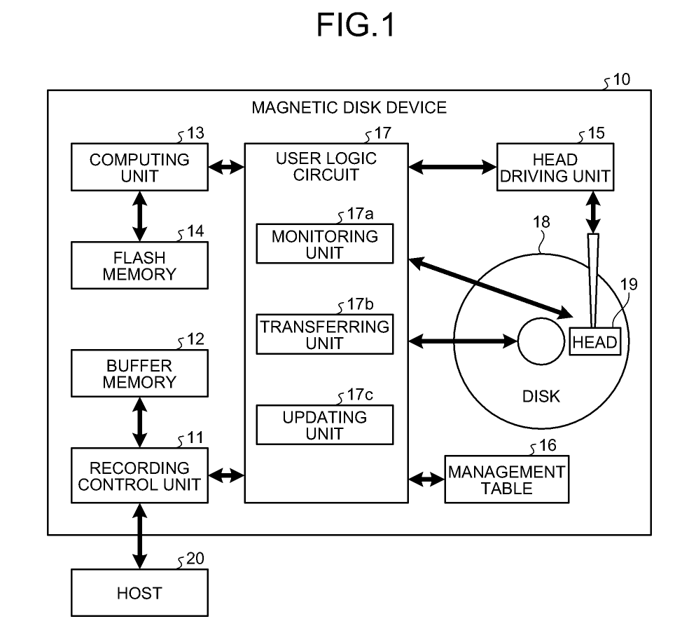

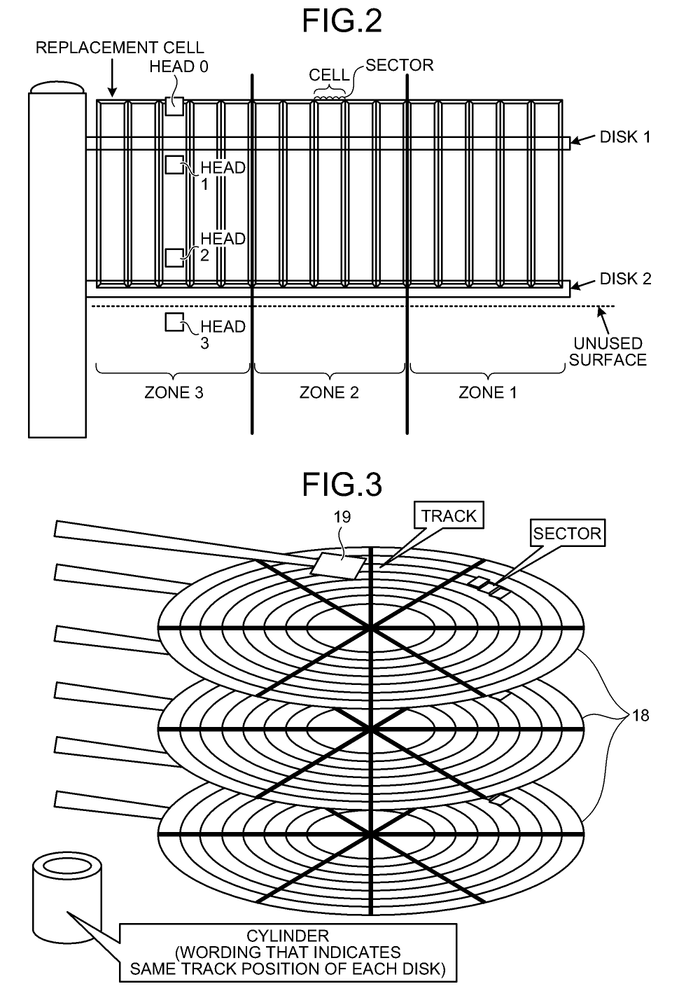

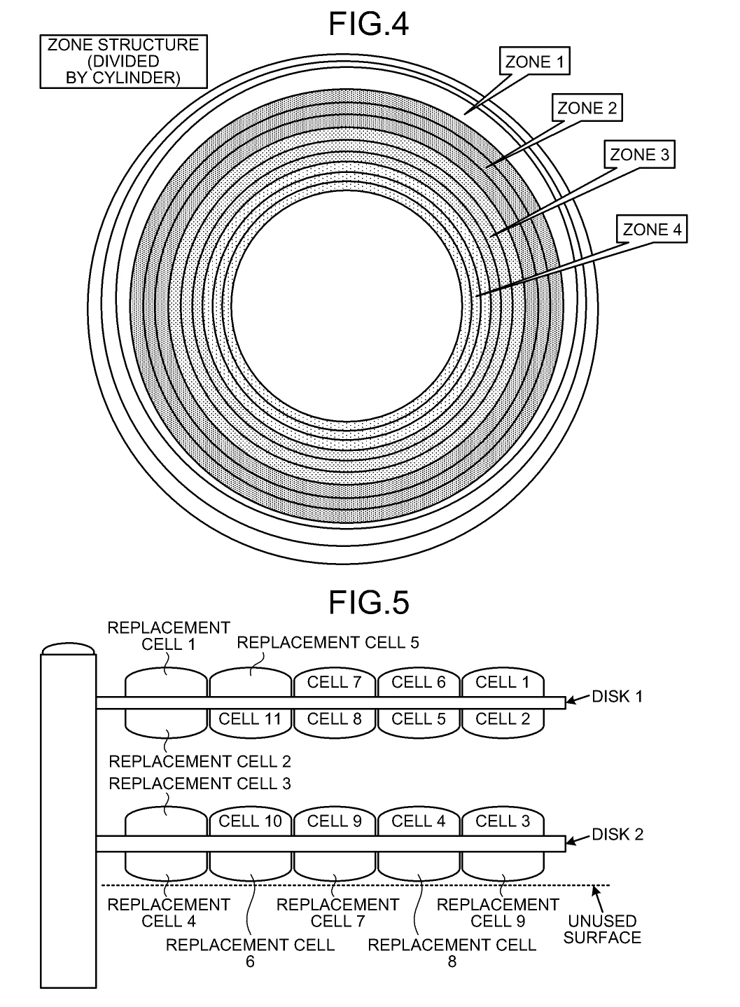

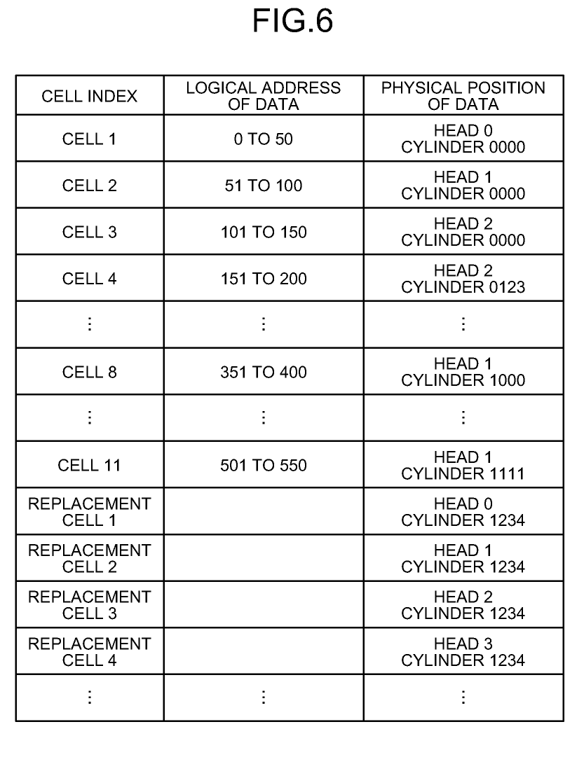

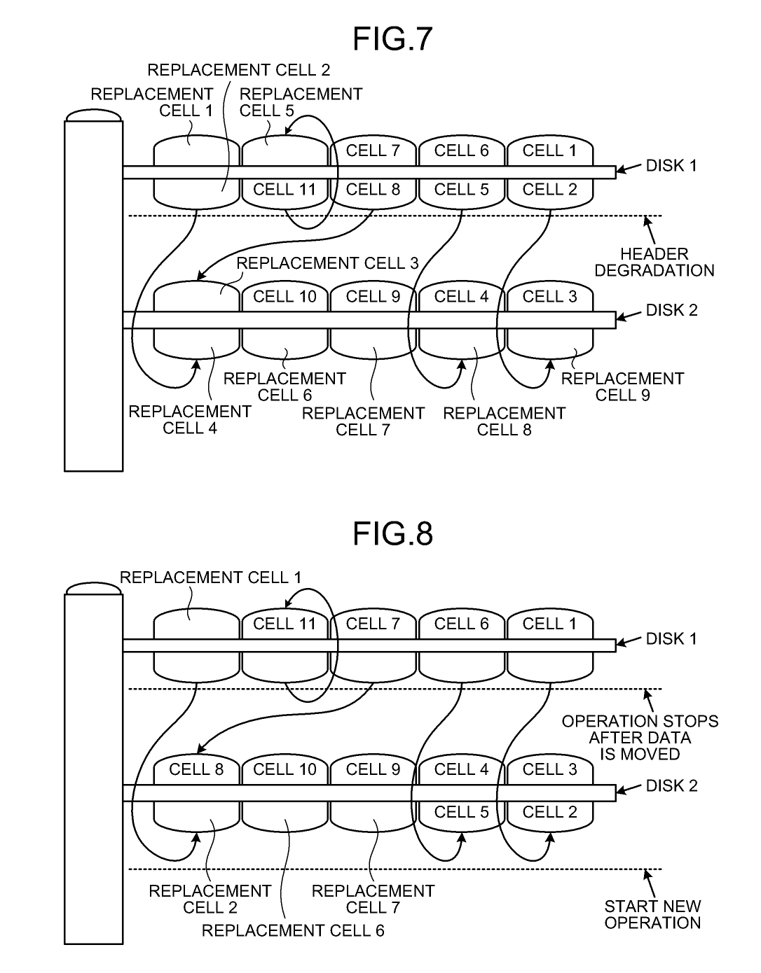

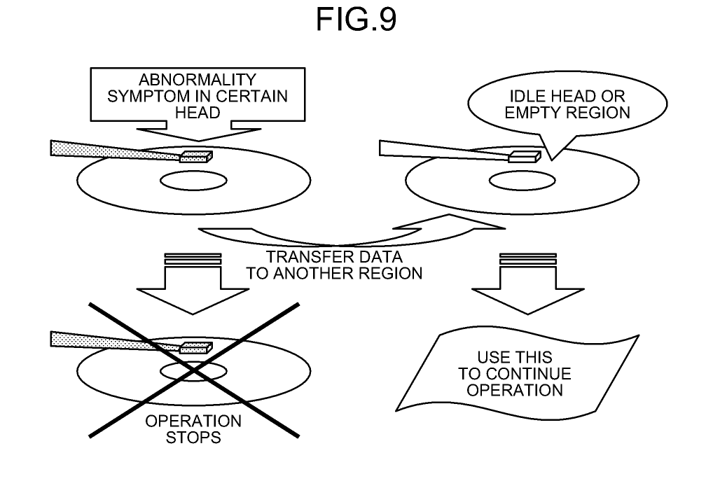

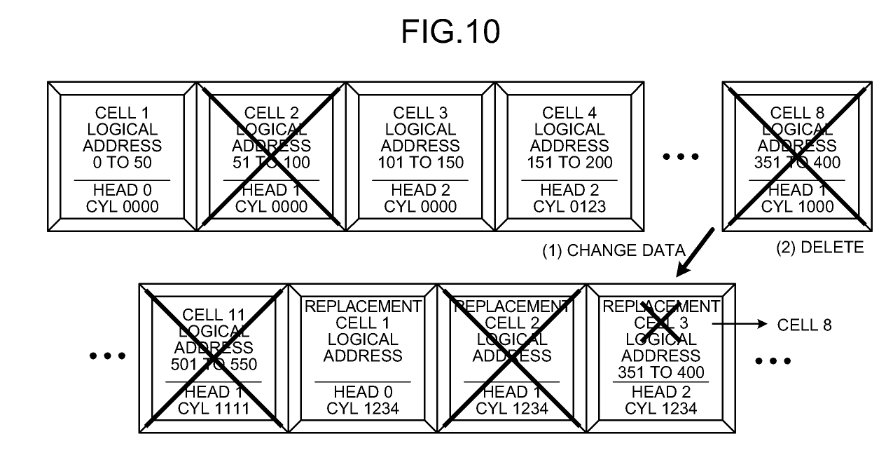

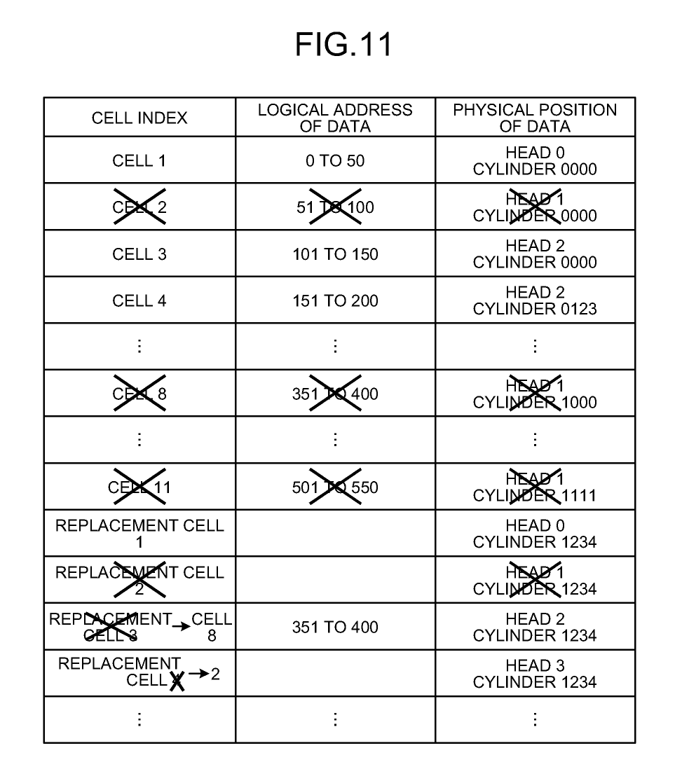

Next, the configuration of the magnetic disk device 10 is explained by using FIGS. 1 to 6. FIG. 1 is a block diagram of the configuration of the disk device according to the first embodiment. FIG. 2 is a drawing for explaining a disk and a head. FIG. 3 is a drawing for explaining the disk and the head. FIG. 4 is a drawing for explaining zones of the disk. FIG. 5 is a drawing for explaining cells of the disk. FIG. 6 is a drawing for explaining a management table. FIG. 7 is a drawing for explaining a data transferring process. FIG. 8 is a drawing for explaining a state after the data transferring process is performed. FIG. 9 is a drawing for explaining the data transferring process. FIG. 10 is a drawing for explaining a management-table updating process. FIG. 11 is a drawing for explaining the management table after the management-table updating process.

As depicted in FIG. 1, the magnetic disk device 10 includes a recording control unit 11, a buffer memory 12, a computing unit 13, a flash memory 14, a head driving unit 15, a management table 16, a user logic circuit 17, a disk 18, and a head 19, and is connected to a host 20. The process of each of these components is explained below.

The disk 18 has recorded thereon various data and position control information. In the disk 18, a process is performed in which data in a cell corresponding to a head where an abnormality is detected by a transferring unit 17b, which will be explained further below, is transferred to a cell corresponding to another head.

The head 19 has mounted thereon an electric-magnetic conversion element formed of a read element and a write element, reading and writing various data and position control information from and into the disk 18. The head 19 is monitored by a monitoring unit 17a, which will be explained further below, to detect whether an abnormality or abnormality symptom occurs in each head.

The disk 18 and the head 19 are explained by using FIGS. 2 to 4. As depicted in FIG. 2, the magnetic disk device 10 includes a plurality of disks 1, 2, . . . , and each disk has heads 1, 2, 3, 4, . . . , on its upper and lower surface.

Also, as depicted in FIGS. 2 and 3, each disk is concentrically divided into tracks, and each track is further radially and equally divided into sectors, which are minimum recording units. Furthermore, each disk is sectioned into sector groups by cell with a plurality of sectors being taken as a unit.

Here, an exemplary state is explained by using FIG. 5 in which a storage region of a disk is sectioned by cell. As exemplarily depicted in the drawing, the upper surface of a disk 1 is sectioned into “replacement cell 1”, “replacement cell 5”, “cell 7”, “cell 6”, and “cell 1”, whilst the lower surface thereof is sectioned into “replacement cell 2”, . . . and “cell 2”.

That is, different cell numbers (cell index) are assigned to each disk surface, and the cells on each disk surface are separately managed. Also, a “replacement” cell is a cell provided in advance as a transfer-destination cell at the time of occurrence of a failure, and no logical address is set in an initial state (see FIG. 6).

Also, as depicted in FIG. 5, all cells on the lower surface of a disk 2 as an unused surface are taken as replacement cells. When an abnormality is detected in any of the heads, data is transferred to a replacement cell on the lower surface of the disk 2. Here, although replacement cells are provided correspondingly to the respective heads in the example of FIG. 5, replacement cells may be provided only to the unused surface and, when an abnormality is detected in any of the heads, data may be transferred to a cell corresponding to the head of the unused surface.

Also, as depicted in FIGS. 2 and 4, each disk is also sectioned into zones with a plurality of cells being taken as a unit. A cylinder represents the same track position of each disk, as depicted in FIG. 3.

Referring back to explanation of FIG. 1, the recording control unit 11 accepts a read access or a write access of data with a logical address specified by the host 20. Specifically, when accepting a read access or a write access, the recording control unit 11 notifies the head driving unit 15 of a read/write control signal via the user logic circuit 17 based on the accepted access. Also, the recording control unit 11 stores the read recording information in the buffer memory 12, and transmits the information to the host 20 via an interface not shown.

The buffer memory 12 is a cache that temporarily stores therein data to be read or write between the host 20 and the disk 18. The computing unit 13 reads data and programs stored in the flash memory to perform various processes. The flash memory 14 has stored therein data and programs needed for various processes by the computing unit 13.

The head driving unit 15 has a driving device, such as a voice coil motor (VCM), and a control circuit of the driving device. Based on a read/write control signal, the head driving unit 15 performs a process of positioning the head 19 that accesses data on the disk 18.

The management table 16 has stored therein an index that uniquely identifies a sector group with a plurality of sectors being taken as a unit, a logical address, and a physical position of a storage region in the disk 18 in association with one another. Specifically, as depicted in FIG. 6, the management table 6 has stored therein “cell index” that uniquely identifies each cell, “logical address of data” assigned to each cell, and “physical position of data” indicative of a physical position of each cell in association with one another.

The user logic circuit 17 performs various processes, and includes, in particular, the monitoring unit 17a, the transferring unit 17b, and an updating unit 17c.

The monitoring unit 17a monitors an abnormality in the heads 19 that read and write data from and into the disk 18. Specifically, the monitoring unit 17a regularly monitors at least one of a gain value, a noise component, an output value, and symmetry of data read by each head 19 to detect an abnormality in the head 19. When detecting an abnormality in any head 19, the monitoring unit 17a notifies the transferring unit 17b, which will be explained further below. A method of monitoring an abnormality in the heads 19 is now specifically exemplified below.

For example, as monitoring the read function of the head 19, the monitoring unit 17a determines whether the level of a read gain value is decreased from a value at the time of shipping by an amount equal to or more than a predetermined value, whether the output of the read value is decreased to a value equal to or more than a predetermined value, and whether a noise equal to or more than a predetermined value occurs in the read value. Also, the monitoring unit 17a determines whether a read waveform is vertically asymmetrical more than defined to monitor an abnormality in each head.

Furthermore, for example, as monitoring the write function of the head 19, the monitoring unit 17a performs a write/read process for checking the head operation to determine whether reading is possible with the output of the level defined in reading. Still further, the monitoring unit 17a performs a write/read process for checking the head operation to determine whether a noise unique to chipping in the write core of the head (damage to the head) is detected to monitor an abnormality in the head.

Still further, for example, the monitoring unit 17a determines whether the wiring of the target head is broken (whether electrical resistance to the head 19 is increased more than defined) and whether a short occurs in the wiring (whether electrical resistance to the head 19 is increased more than defined) to monitor an abnormality in each head.

When an abnormality is detected in the head by the monitoring unit 17a, the transferring unit 17b transfers data in the cell corresponding to the head where the abnormality is detected to a cell corresponding to another head. Specifically, upon receiving from the monitoring unit 17a a notification that an abnormal head is detected, the transferring unit 17b transfers data in each cell corresponding to the head where the abnormality is detected to a replacement cell corresponding to each of the heads other than the head where the abnormality is detected, and notifies the updating unit 17c, which will be explained further below, of information about the transfer-source cell and the transfer-destination cell.

When the total data amount in the transfer-source cell is larger than the total data amount in the transfer-destination cell, the transferring unit 17b prioritizes transferring of data in a cell with a high access frequency. After the transferring process, the magnetic disk device 10 stops operation of the head 19 where the abnormality is detected.

The data transferring process is specifically explained by using FIGS. 7 and 8. As depicted in FIG. 7, when a head serving the lower surface of a disk 1 degrades and an abnormality is detected therein, data in a replacement cell 2 is transferred to a replacement cell 4, data in a cell 11 is transferred to a replacement cell 5, data in a cell 8 is transferred to a replacement cell 3, data in a cell 5 is transferred to a replacement cell 8, and data in a cell 2 is transferred to a replacement cell 9.

Then, as depicted in FIG. 8, after data transfer, the magnetic disk device 10 stops the operation of the head serving the lower surface of the disk 1, and newly starts operation with a head serving the lower surface of a disk 2.

That is, as depicted in FIG. 9, when an abnormality symptom is present in a head, data is transferred to an empty region and an unused head is used to continue the operation. With this, data is ensured in the magnetic disk device. At the same time, after data transfer, the operation of the abnormal head is stopped, and then the transferred data is used to continue the operation of the drive. Alternatively, the magnetic disk device 10 may perform a transferring process as an interrupt process while continuing a normal operation, thereby eliminating an operation stop period of the entire device.

Referring back to FIG. 1, the updating unit 17c updates the management table 16 so as to update the logical address of the transfer destination to the logical address of the transfer source and to update the index of the transfer destination to the index of the transfer source.

Specifically, as exemplified in FIG. 10, upon receiving information about the transfer-source cell and the transfer-destination cell from the transferring unit 17b, the updating unit 17c updates the management table 16 so as to update the logical address of a transfer-destination cell “replacement cell 3” to the logical address “351-400” of a transfer-source cell “cell 8”. Furthermore, the updating unit 17c updates the index of the transfer destination “replacement cell 3” to the index of the transfer source “cell 8” (see (1) in FIG. 1).

Then, the updating unit 17c deletes from the management table 16 the data in the transfer-source cell “cell 8” (see (2) in FIG. 10). In this manner, in the management table 16 after the management-table updating process is performed, as exemplified in FIG. 11, the logical address of the transfer destination is updated to the logical address of the transfer source, and also the index of the transfer destination is updated to the index of the transfer source.

### Process by the Magnetic Disk Device

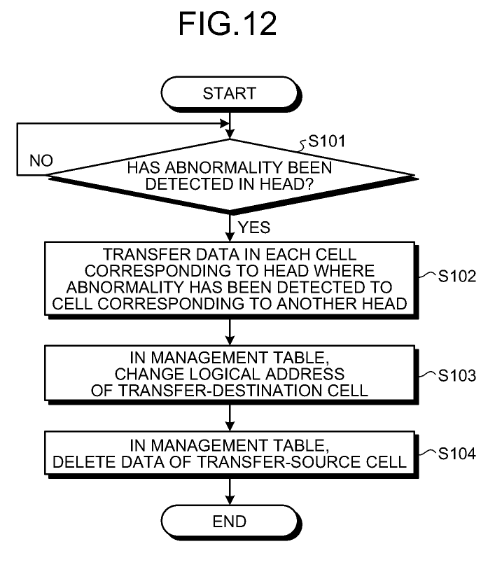

Next, the process by the magnetic disk device 10 according to the first embodiment is explained by using FIG. 12. FIG. 12 is a flowchart of the process operation of the magnetic disk device 10 according to the first embodiment.

As depicted in the drawing, the magnetic disk device 10 regularly monitors an abnormality in the heads 19 (Step S101) and, when detecting an abnormality in any head (Yes at Step S101), transfers data in each cell corresponding to the head where the abnormality is detected to a replacement cell corresponding to another head (Step S102).

The magnetic disk device 10 then updates the management table 16 so as to update the logical address of the transfer-destination cell to the logical address of the transfer-source address (Step S103). The magnetic disk device 10 then deletes the data in the transfer-destination cell from the management table 16 (Step S104).

### Effects of the First Embodiment

As explained above, the magnetic disk device 10 monitors an abnormality in the heads 19 and, when an abnormality is detected in any one of the heads, transfers data in a cell corresponding to the head where the abnormality is detected to a cell corresponding to another head. Then, after the data is transferred, in the management table 16, the logical address of the transfer destination is updated to the logical address of the transfer source, and the cell index of the transfer destination is updated to the cell index of the transfer source. As a result, the cell index is changed according to the change of the data transfer. Therefore, the operation can easily continue without modifying software or the like and adding a table to be separately managed even after the occurrence of a failure.

Also, according to the first embodiment, when an abnormality is detected in a head, data is transferred to a cell corresponding to each of the heads other than the head where the abnormality is detected. Therefore, compared with the case where data is transferred to a cell corresponding to one head, the transferring process can be performed with a shorter time.

Further, according to the first embodiment, the magnetic disk device 10 monitors at least one of the gain value, the noise component, the output value, and symmetry of data read by the head. Therefore, an abnormality in a head can be accurately detected.

### [b] Second Embodiment

While the embodiment of the present invention has been explained, the present invention can be implemented in various different forms other than the embodiment explained above. Another embodiment included in the present invention is now explained below as a second embodiment.

(1) Transfer Destination

In the first embodiment, the data in the transfer-source cell is transferred to the data in the transfer-destination cell. However, the present invention is not meant to be restricted to this. Alternatively, the data in the transfer-source cell may be transferred to the flash memory.

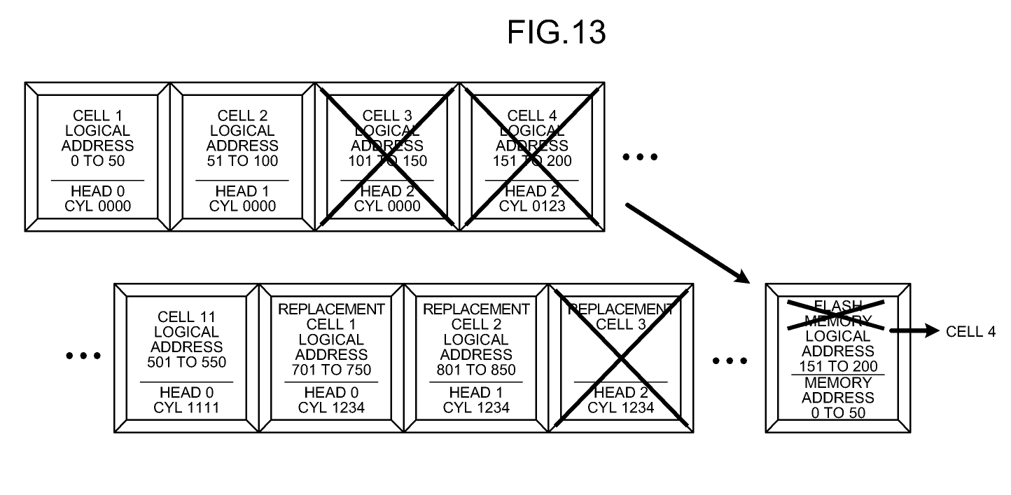

Here, as exemplified in FIG. 13, an example of the management table is explained when data in a transfer-source cell “cell 4” is transferred to the flash memory. As depicted in the drawing, the magnetic disk device stores a logical address “151-200” of the transfer-source cell “cell 4” in association with a memory address “0-50” of the flash memory.

The magnetic disk device then updates the index of the transfer destination “flash memory” to the index of the transfer source “cell 4”. The magnetic disk device then deletes the data in the transfer-destination cell “CELL 4” from the management table 16.

(2) Zone

In the first embodiment, the process of transferring in units of cells is explained. However, the present invention is not meant to be restricted to this. Alternatively, a process of transferring in units of zones may be performed. Also, each zone (or cell) may go across storage regions corresponding to the heads.

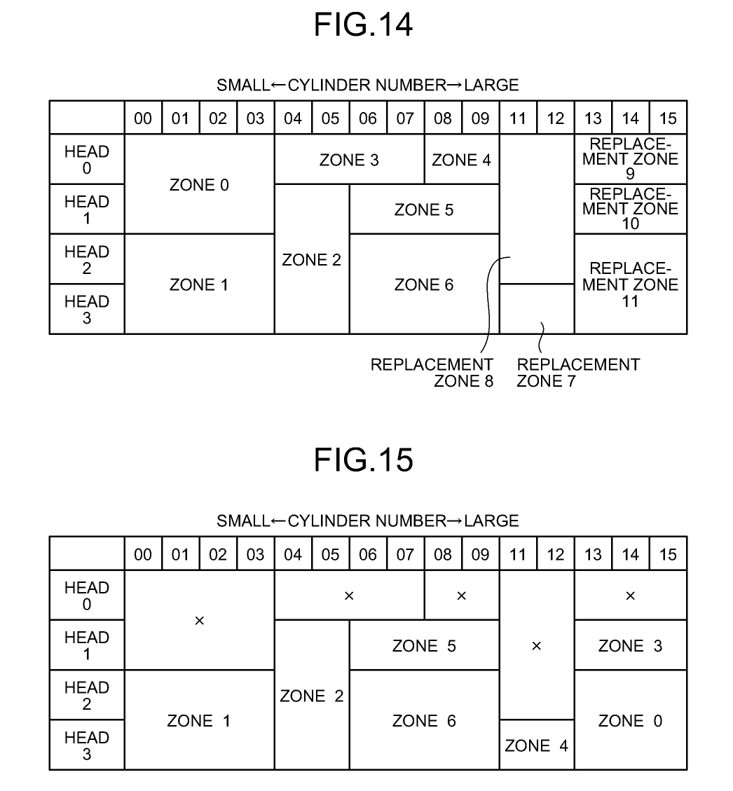

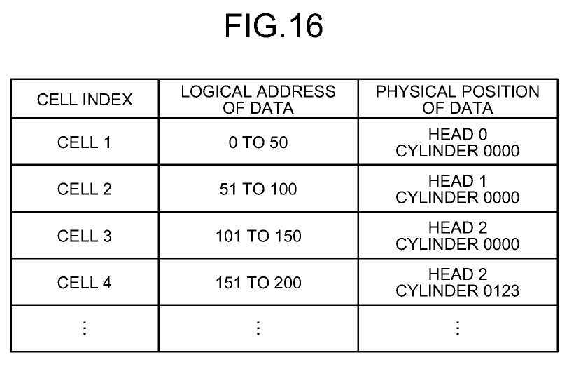

For example, as exemplified in FIG. 14, in a disk of the magnetic disk device, a zone “0” goes across a head “0” and a head “1”. Also, the storage region of each zone has a different size.

In the magnetic disk having the disk sectioned by such zones, a data transferring process when a failure occurs in a head is explained by using an example depicted in FIG. 15. As exemplified in the drawing, when an abnormality is detected for the head “0”, the magnetic disk device transfers data in the zone “0”, a zone “3”, and a zone “4” to a replacement zone “11”, a replacement zone “10”, and a replacement zone “7” corresponding to other heads, respectively.

(3) Data Size

In the first embodiment, data in each cell corresponding to the head where an abnormality is detected is transferred to a replacement cell corresponding to each of the heads other than the head where the abnormality is detected. Alternatively, data in each cell corresponding to the head where the abnormality is detected may be transferred to a replacement cell corresponding to one head other than the head where the abnormality is detected.

In this manner, with data in each cell corresponding to the head where the abnormality is detected being transferred to a replacement cell corresponding to one head other than the head where the abnormality is detected, a data transferring process can be performed with ease. Also, for the heads other than the head to which the data is to be transferred, normal operation can continue.

(4) System Configuration and Others

Each component of the magnetic disk device depicted is conceptual in function, and is not necessarily physically configured as depicted. That is, the specific patterns of distribution and unification of the components are not meant to be restricted to those depicted in the drawings. All or part of the components can be functionally or physically distributed or unified in arbitrary units according to various loads and the state of use (for example, the movement control unit and the meeting-point calculating unit may be unified). Further, all or arbitrary part of the process functions performed in each component can be achieved by a Micro Controller Unit (MCU) (or a controlling device, such as a Central Processing Unit (CPU) or a Micro Processing Unit (MPU)) and a program analyzed and executed on that MCU (or the controlling device, such as CPU or MPU), or can be achieved as hardware with a wired logic.

The apparatus disclosed herein can easily continue operation after a failure occurs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A data managing method, comprising:
monitoring an abnormality in a plurality of heads that read and write data from and into a recording medium;
transferring data in a recording region corresponding to the head where an abnormality is detected in one of the heads at the monitoring to a recording region corresponding to another head; and
updating a management table when the data is transferred at the transferring, the management table storing an index that uniquely identifies a sector group with a plurality of sectors being taken as one unit, a physical position of each storage region of the storage medium, and a logical address in association with one another, so as to update a logical address of a transfer destination to a logical address of a transfer source and to update an index of the transfer destination to an index of the transfer source.

2. The data managing method according to claim 1, wherein
the transferring includes transferring, when an abnormality is detected in the head, the data to a recording region of each of other heads.

3. The data managing method according to claim 1, wherein
the transferring includes transferring, when an abnormality is detected in the head, the data to a recording region of another head.

4. The data managing method according to claim 1, wherein the monitoring includes monitoring at least one of a gain value, a noise component, an output value, and symmetry of data read by the heads.

5. An information storage apparatus, comprising:
a plurality of heads;
a recording medium that has reading region corresponding to each of the heads;
a management table that stores an index that uniquely identifies a sector group with a plurality of sectors being taken as one unit, a physical position of each storage region of the storage medium, and a logical address in association with one another;
a monitoring circuit that monitors an abnormality in the heads;
a transferring circuit that transfers data in a recording region corresponding to one of the heads where an abnormality is detected by the monitoring circuit to a recording region corresponding to another head; and
an updating circuit that updates the management table when the data is transferred to the transferring circuit so as to update a logical address of a transfer destination to a logical address of a transfer source and to update an index of the transfer destination to an index of the transfer source.

6. The information storage apparatus according to claim 5, wherein
the recording media includes a plurality of recording media.

7. A data management circuit for an information storage apparatus, comprising:
a management table that stores an index that uniquely identifies a sector group with a plurality of sectors being taken as one unit, a physical position of each storage region of a storage medium, and a logical address in association with one another;
a monitoring circuit that monitors an abnormality in a plurality of heads for reading and writing data from and into the storage medium;
a transferring circuit that transfers data in a recording region corresponding to one of the heads where an abnormality is detected by the monitoring circuit to a recording region corresponding to another head; and
an updating circuit that updates the management table when the data is transferred to the transferring circuit so as to update a logical address of a transfer destination to a logical address of a transfer source and to update an index of the transfer destination to an index of the transfer source.

8. The data management circuit according to claim 7, wherein
the transferring circuit transfers, when an abnormality is detected in the head, the data to a recording region of each of other heads.
